(19) United States
(12) Patent Application Publication
(10) Pub. No.: US 2006/0216669 A1
(43) Pub. Date: Sep. 28, 2006

(54) Apparatus and method for performing a dental procedure

(76) Inventor: Hessam Ahani, San Mateo, CA (US)

Correspondence Address: Law Offices of John W. Carpenter;Suite 2004, 155 Jackson St., San Francisco, CA, 94111, US

(21) Appl. No.: 11/351,704

(22) Filed: Feb. 10, 2006

Related U.S. Application Data
(60) Provisional application No. 60/664,985, filed on Mar. 24, 2005.

(51) Int. Cl. A61C 5/14

(52) U.S. Cl. 433/136; 433/32

(57) ABSTRACT

An assembly for conducting a dental procedure comprising a frame, and an electrical conductor assembly secured to the frame. The electrical conductor assembly includes a connector body having at least one opening for receiving at least one adapter, and a conductor member for engaging the adapter. An electrical coupling assembly is coupled to the conductor member such that current may be conducted from an instrument, through the electrical coupling assembly, through the conductor member and to the adapter which enables the electrical current to be furnished to a file. A method for conducting a dental procedure comprising exposing a tooth through a flexible sheet member connected to a frame having secured thereto an electrical connector assembly, and conducting a dental procedure on the exposed tooth.

### CROSS-REFERENCE TO RELATED APPLICATIONS

This patent application is related to Provisional Patent Application having application No. 60/664,985, filed Mar. 24, 2005, and fully incorporated herein by reference thereto as if repeated verbatim immediately herein. Benefit of the Mar. 24, 2005 filing date for the Provisional Patent Application is claimed.

### BACKGROUND OF THE INVENTION

1. Field of the Invention

Embodiments of the present invention relate to the field of dentistry, specifically the art of endodontics, also known as root canal therapy. More specifically, embodiments of the present invention provide an apparatus and method for performing a dental procedure.

2. Description of the Background Art

Endodontics is the treatment of the area inside of a tooth. The pulp chamber of a tooth is a hollow cavity with root canals leading from the pulp chamber to the tip of the roots. The chamber and canals include pulp or nerve tissue that can be infected by bacteria leading to a tooth abscess. Root canal treatment removes all tissue within the pulp chamber and root canals, which are then filled with an inert material.

The method of performing root canal treatment includes anesthetizing the patient and placement of a rubber dam assembly. The rubber dam assembly includes a rubber dam (i.e., a flexible rubber sheet member) employed to isolate the tooth to be treated, therefore allowing the tooth chamber to remain free of contamination and also ensuring that the cleansers used in the tooth do not enter the patient's mouth. Preparation of the rubber dam assembly includes placing at least one hole in the rubber dam using a rubber dam punch. The tooth or teeth to be treated pass through the hole. The rubber dam is then placed in a rubber dam frame by inserting spikes associated with the rubber dam frame into and through the rubber dam in proximity to edges of the rubber dam. FIG. 1 illustrates a conventional rubber dam frame A having spikes B. The next step involves placing a tooth clamp inside the punched hole and spreading the clamp so the clamp is capable of surrounding the tooth that is to be treated. The entire assembly is then slid on top of the tooth to be treated.

After placement of the rubber dam the dentist then drills an access hole into the pulp chamber of the tooth using a dental drill. Next, an endodontic file is used to clean out the bacteria and tissue within the pulp chamber and root canal. As best shown in FIG. 2 a conventional endodontic file includes an electrically conductive metal stem F having a non conductive handle C mounted to the top of the stem F. The lower portion of the stem F includes a cutting portion G with a plurality of cutting flutes. The stem F is manually inserted into a tooth hole leading to the interior of the tooth I and is rotated and moved in and out of the hollow interior by means of the dentist twisting pushing and pulling the handle C relative to the tooth I. The cutting portion G then removes the tissue from the canal and begins to shape the canal suitably for filling with the inert material.

It is important in the root canal process to know at all times the length of the canal. Ideally the root canal should be filed to the end of the root or apex O of the tooth I. Determining the length of the canal is done using radiographs and more recently an electrical device known as an apex locator, such as the Root ZX by J. Morita. The apex locator (labeled “instrument” in FIG. 2) is used by placing a manually operable file holder D removably attached to the stem F portion of the file. The other end of the file holder D is attached to the apex locator via a flexible conductor H. As the file passes down the canal the dentist engages and disengages the file holder D until the apex locator display beeps and indicates that the end of the canal has been reached. A non conductive washer, known as a stopper E and which has been previously placed on the non cutting portion of the file, is then moved to a reference point on the tooth I. The file is then removed and measured to the stopper E and the length of the canal is determined. In some cases the file is then reinserted and a radiograph is taken to verify that the file is at the correct length.

### SUMMARY OF EMBODIMENTS OF THE INVENTION

Embodiments of the present invention provide an assembly for conducting a dental procedure. The assembly includes a frame, and an electrical conductor assembly secured to the frame. The electrical conductor assembly comprises a connector body having at least one opening for receiving at least one adapter, and a conductor member for engaging the adapter. The assembly for conducting a dental procedure further comprises an electrical coupling assembly coupled to the conductor member. The assembly for conducting a dental procedure may further include a file assembly comprising a file, a flexible electrical conductor coupled to the file, and an adapter secured to the flexible electrical conductor and removaly disposed in the opening of the connector body.

Embodiments of the present invention further provide a method for conducting a dental procedure comprising exposing a tooth through a flexible sheet member connected to a frame having secured thereto an electrical assembly, and conducting a dental procedure on the exposed tooth.

These provisions together with the various ancillary provisions and features which will become apparent to those skilled in the art as the following description proceeds, are attained by the embodiments of the of the present invention, preferred embodiments thereof being shown with reference to the accompanying drawings, by way of example only, wherein:

### BRIEF DESCRIPTION OF THE DRAWINGS

FIG. 1 is a top plan view of a prior art rubber dam frame.

FIG. 2 is an elevational view of a prior art endodontic file connected to a measuring instrument via a file holder.

FIG. 3 is a top plan view of an embodiment of the rubber dam frame having an electrical coupling assembly.

FIG. 4 is a top plan view of an embodiment of the rubber dam frame having an electrical coupling assembly coupled to a measuring instrument via a file holder.

FIG. 5 is an elevational view of a file assembly as described in patent application Ser. No. 10/133,269 and fully incorporated herein by reference thereto.

FIG. 6 is a top plan view of an embodiment of the rubber dam frame with the electrical coupling assembly attached in conjunction with an embodiment of the endodontic file described in patent application Ser. No. 10/133,269.

FIG. 7 is a partial vertical cross sectional view of the rubber dam frame electrical connector assembly attached in conjunction with an embodiment of the endodontic file described in patent application Ser. No. 10/133,269, and showing the electrical continuity between the parts.

FIG. 8 is a top plan view of an embodiment of the invention coupled to an instrument (e.g., an apex locator) and having a file inserted into an exposed tooth of a patient.

FIG. 9 is a top plan view of another embodiment of the invention.

FIG. 10 is a partial enlarged view of a tooth exposed in an opening within the rubber dam and having a file extending into a root canal of the tooth.

FIG. 11 is an elevational view of a face of an apex locator.

FIG. 12 is a partial side elevational view taken in direction of the arrows and along the plane of line 12-12 in FIG. 9.

FIG. 13 is a partial vertical sectional view taken in direction of the arrows and along the plane of line 13-13 in FIG. 9.

FIG. 14 is a partial vertical sectional view of the electrical connector assembly having a male adaptor slidably inserted therein and having a file holder electrically coupled to the metal bar.

FIG. 15 is a partial top plan view of another embodiment of the invention showing the metal bar off-set from the electrical connector assembly and extending through the rubber dam frame.

FIG. 16 is a partial bottom plan view of the embodiment of the invention in FIG. 15 showing the electrical connections between the terminating ends of the metal bar and the bottom electrical outlets for the female openings in the electrical connector assembly.

FIG. 17 is a schematic view of another embodiment of the invention showing an electrical conduit having a male connector mating with a female connector and passing through the rubber dam frame for electrically coupling to the bottom electrical outlets (see FIG. 16) for the female openings in the electrical connector assembly.

FIG. 18 is a schematic diagram illustrating the flow of current for various embodiments of the invention.

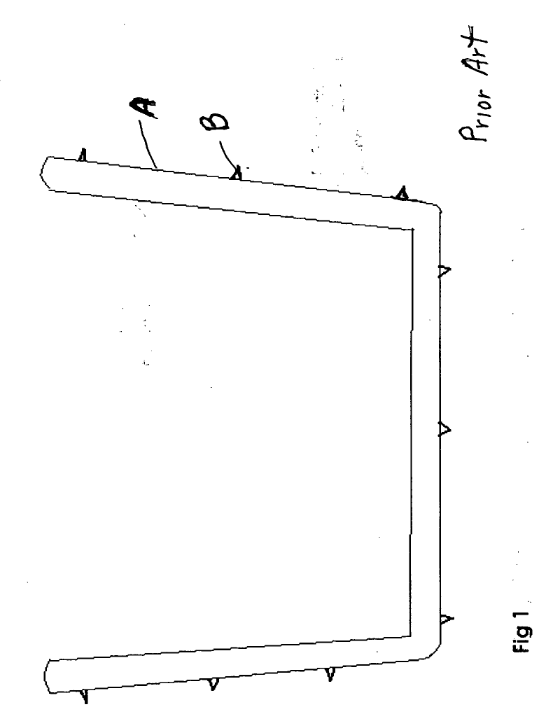

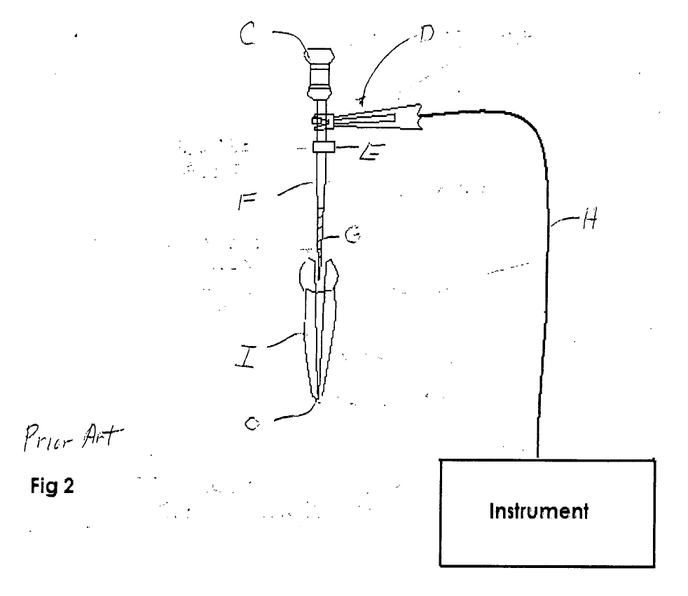

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

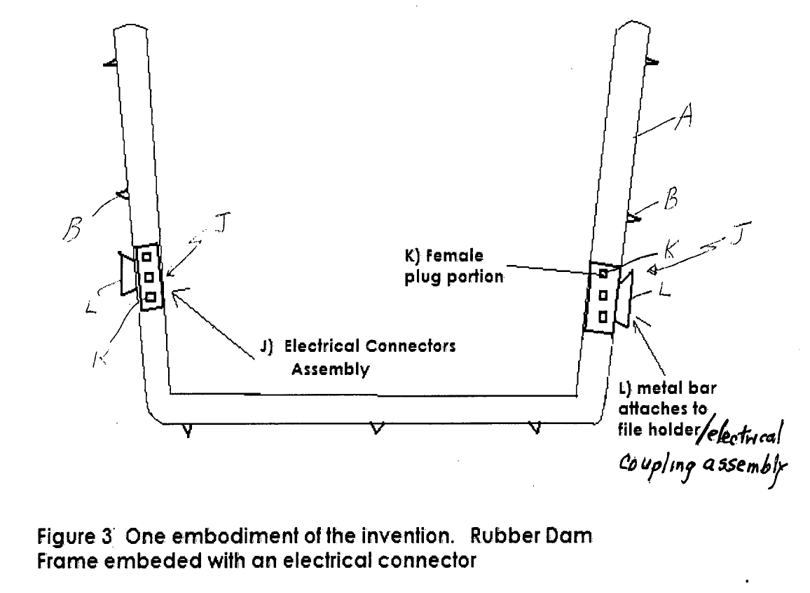

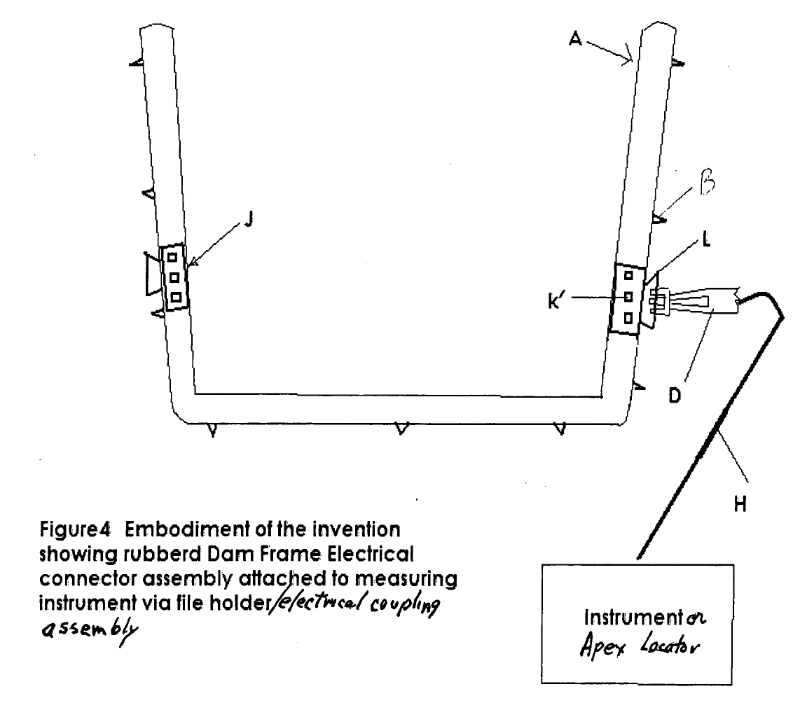

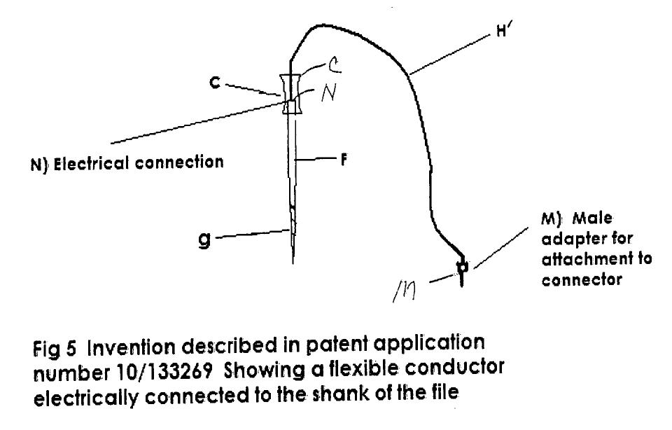

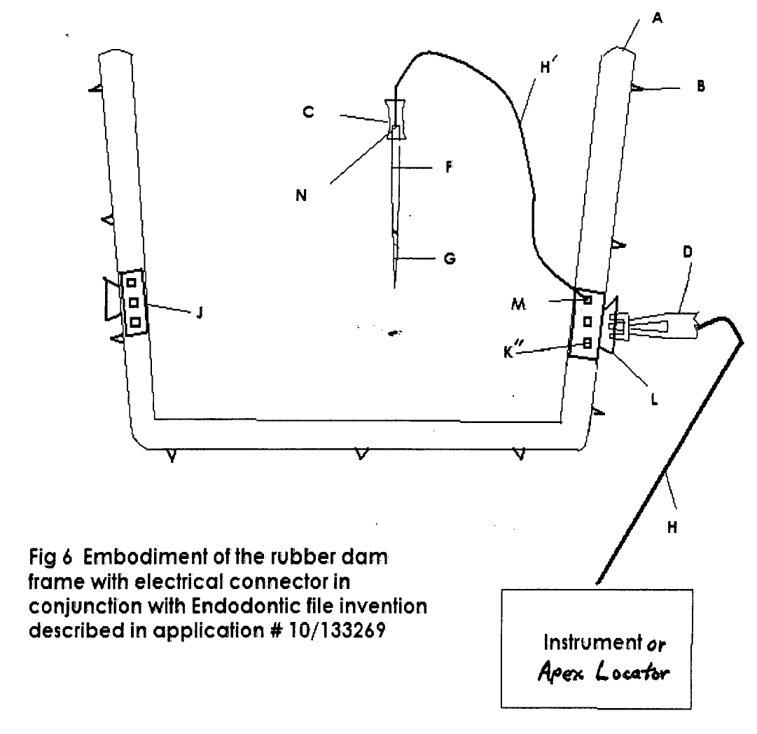

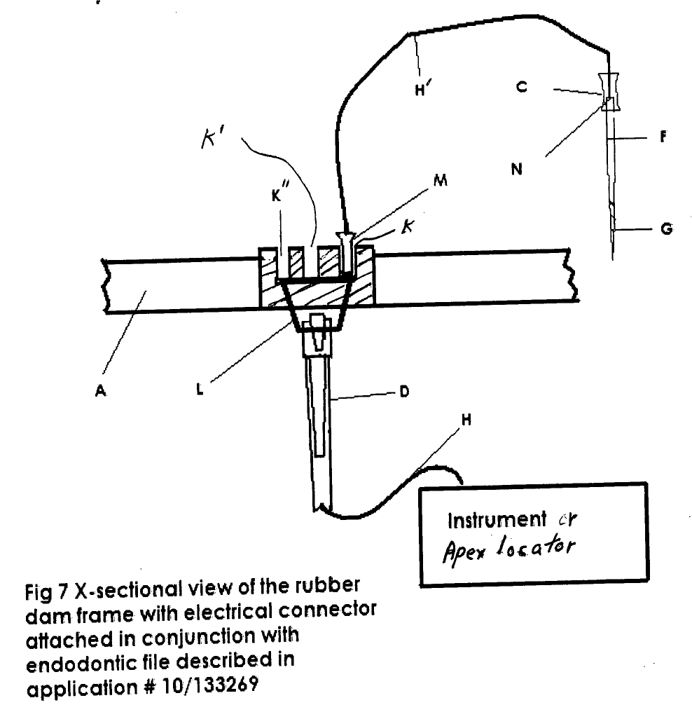

Referring now to FIGS. 3-7 for an embodiment of the present invention, there is seen a rubber dam frame A with an electrical connector assembly J attached to it, as best shown in FIG. 3. Embodiments of the invention may be employed in conjunction with embodiments of another invention described in patent application Ser. No. 10/133,269, fully incorporated herein by reference thereto as if repeated verbatim immediately hereinafter. The electrical connector assembly J has female plug portions K, K′, and K″ and may be placed anywhere along the rubber dam frame A or all around the rubber dam frame A. The electrical connector assembly J comprises a metal bar L that is electrically coupled with the female plug portion K (as well female portions K′ and K″) so that electrical current may pass from the metal bar L to the female plug portion K (as well as to female portions K′ and K″), and vice versa. The file holder D (now functioning as an electrical coupling assembly rather than a file holder) from the apex locator is then removably attached to the metal bar L (see FIG. 4) rather than to the file stem F. As indicated, the electrical coupling assembly D (formerly functioning as a file holder) is connected to the instrument or apex locator via the electrical conductor H. For various embodiments of the invention, the endodontic file illustrated in FIG. 5 may be used with embodiments of the present invention. The endodontic file in FIG. 5 includes a male adapter M connected to an electrical conductor H′ which passes through the handle C to make electrical contact with the file stem F of the file at N. The file stem F has cutting surfaces G. The endodontic file illustrated in FIG. 5 may be directly coupled to the electrical connector assembly J by plugging a male adapter M into the female plug portion K of the electrical connector assembly J. The net result is that direct current may flow from the metal conductive portion F of the file, through the electrical connection N, through the flexible conductor H′, through the male adapter M, through the electrical connector assembly J (i.e., through the female plug portion K and through the metal bar L) to the electrical coupling assembly (formerly the file holder) D and finally to the apex locator via electrical conductor H. FIG. 6 illustrates the entire assembly for an embodiment of the invention. FIG. 7 is a partial vertical cross sectional view of the rubber dam frame connector assembly showing the electrical continuity between the parts. The figures show only one possible configuration of connectors, the connectors could be placed anywhere on the rubber dam frame A. Furthermore, any type of connector and connection could be used. For example, the electrical coupling assembly D and the metal bar L could be replaced with wires and a male/female type connector.

Continuing to refer to FIGS. 3-7 for operation of an embodiment of the present invention, the dentist initially anesthetizes the patient and subsequently disposes the rubber dam frame (having the electrical connector assembly) into the mouth of a patient so that the tooth upon which a root canal is to be performed is exposed through an opening in the rubber dam. This procedure utilizes the rubber dam, a hole punch, a rubber dam clamp, and a clamp holder. The dentist would then select the endodontic file with flexible connector (see FIG. 5) and plug the male adapter M into the female plug portion K. The dentist would then attach the file holder D to the metal bar L. The apex locator would be turned on and the ground wire would be connected to the patient's lip. After drilling the access in the tooth, the dentist would then grasp the file and work it down the canal with his or her preferred motion. When the end of the root is reached, the apex locator will indicate it. In this way the dentist will have much less need to measure the canal and will have full tactile sense of the operation since there is no file holder attached to the file, preventing its turning and advance. The dentist will also have a clear indication of where the apex is without having to place the stopper and measuring the stopper against a reference point. After the dentist is satisfied with the initial opening made by the first file, a male adapter of a second (thicker) file (i.e., a file having a shank or stem portion with a greater or larger diameter than the shank or stem portion of the first file, file F) would then be placed into the female plug portion K′ and used in much the same way to enlarge the opening of the first file. Similarly, after the dentist is satisfied with the subsequent opening made by the second file, a male adapter of a third (thicker) file (i.e., a file having a shank or stem portion with a greater or larger diameter than the shank or stem portion of the second file) would then be placed into the female plug portion K″ and used in much the same way to enlarge the opening made by the second file. This would be continued until the dentist is satisfied with the shape of the canal and/or decides to use a rotary instrument. The purpose of embodiments of the invention is to give the dentist a direct connection to the apex locator, allowing him or her to feel the file and to see the apex locator reading at the same time. The flow of electrical current would be in accordance with the schematic drawing of FIG. 18.

In another embodiment of the invention the electrical connector assembly could be mounted on a mounting device, which could then be attached removably to the rubber dam frame. For example the connector could be placed atop a spring loaded clamp which could then be attached and removed from the rubber dam frame as needed. The electrical coupling assembly (i.e., the file holder) would then attach to a conductive portion (i.e., the metal bar) of the electrical connector assembly.

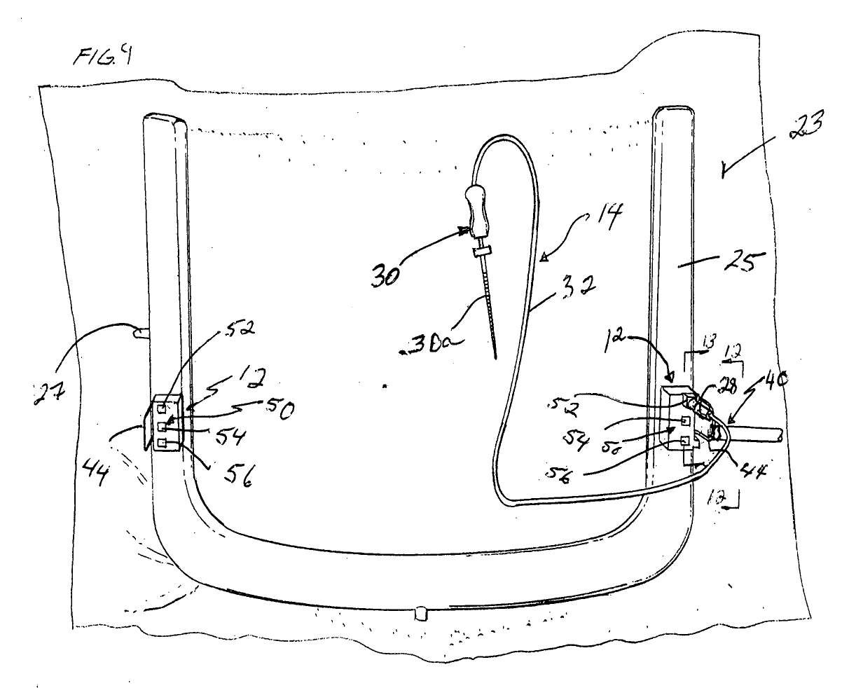

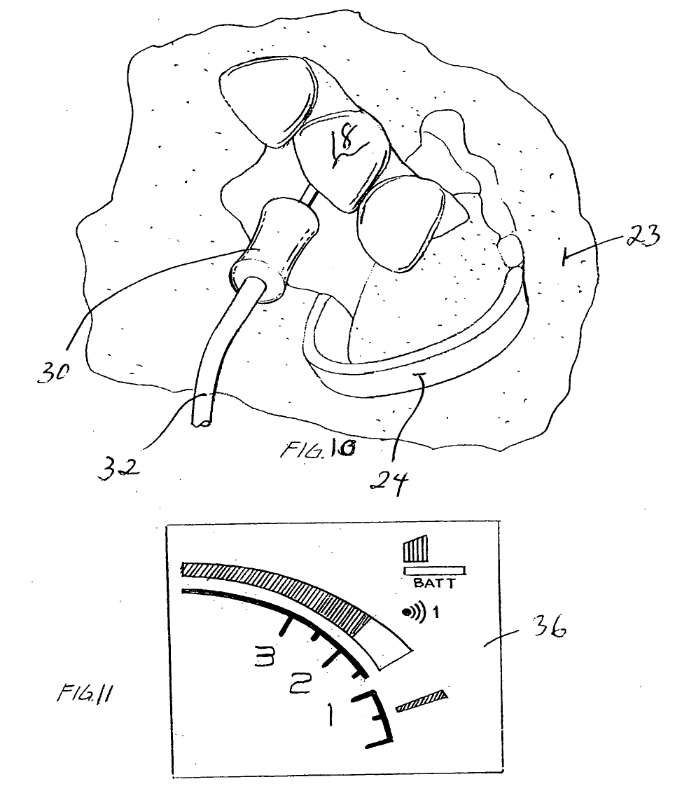

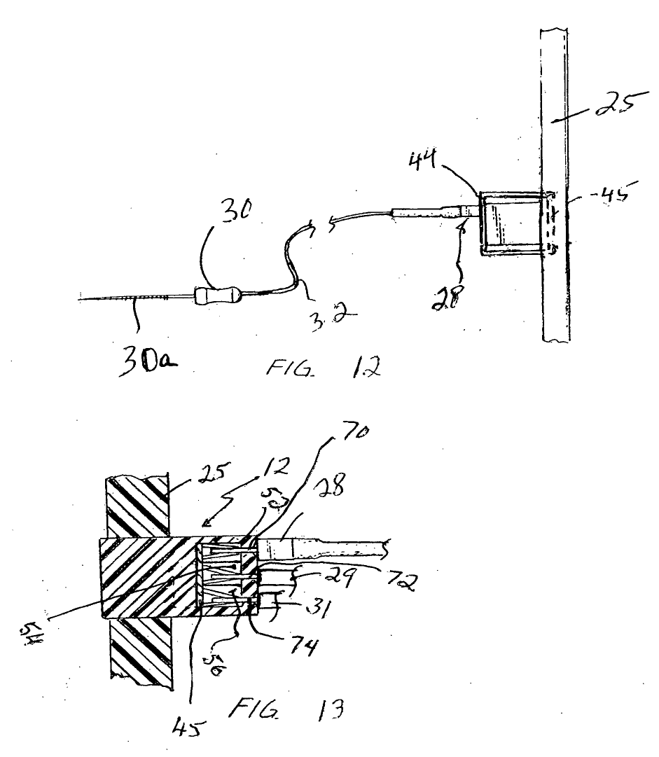

Referring in detail now to FIGS. 8-18, there are seen additional embodiments of the invention. There is seen in FIG. 8 a rubber dam assembly, generally illustrated as 10, having an electrical connector assembly 12 engaged to a file assembly 14 and to an apex locator assembly 16. A tooth 18 of a patient 20 is exposed through an opening 22 in a rubber dam 23 secured to a frame 25 having spikes 27 for engaging and holding the rubber dam 23, and a clamp member 24 is engaged around one or more teeth for holding steadfastly the rubber dam assembly 10 in place. The file assembly 14 has a file 30, and a male adapter 28 removably engaged to the electrical connector assembly 12. The file 30 has a stem 31. An electrical conduit 32 electrically interconnects the male adapter 28 with the file 30 for conducting current (e.g., in accordance with the schematic drawing of FIG. 18) to determine the location of the file 30 within a root canal of the tooth 18.

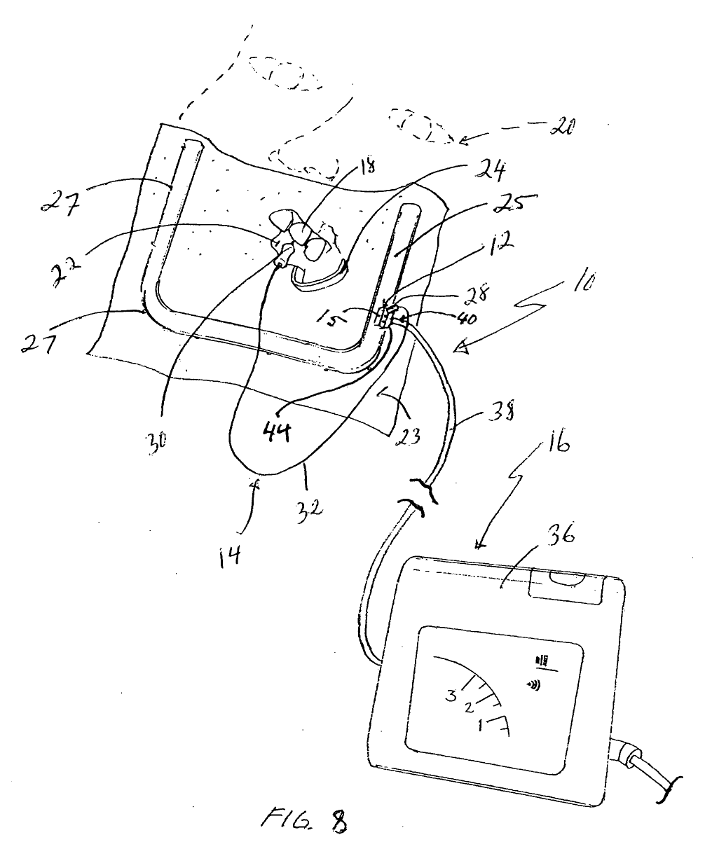

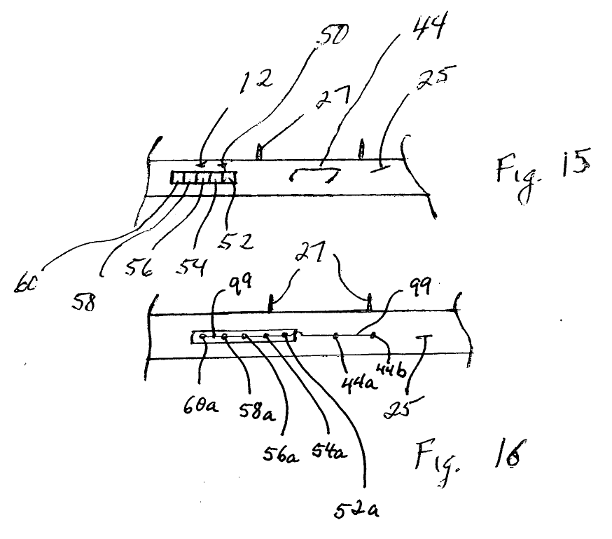

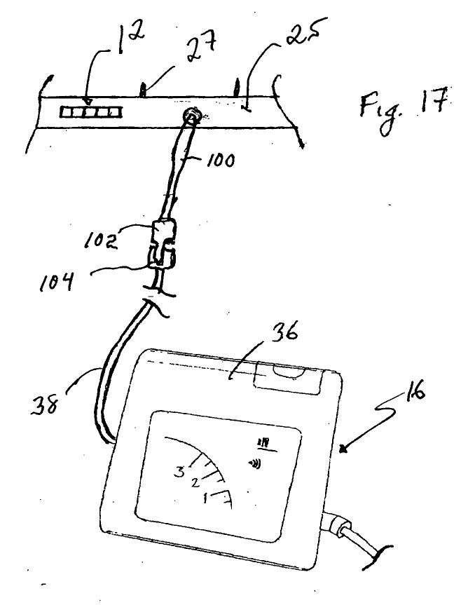

In one embodiment of the invention (e.g., see FIGS. 8, 9 and 14) the electrical connector assembly 12 has a body 15, a metal bar 44 and female openings, generally illustrated as 50 and passing into the body 15. The metal bar 44 has a base bar 45. The metal bar 44 may be located at any suitable location for being electrically coupled (either directly or indirectly) to a male adaptor. By way of example only, the metal bar 44 may pass through the body 15 of the electrical connector assembly 12 (e.g., see FIG. 7), or the metal bar 44 may be generally contiguous to the body 15 of the electrical connector assembly 12 (e.g., see FIGS. 8 and 9), or the metal bar 44 may be remotely disposed with respect to the body 15 of the electrical connector assembly 12 (e.g., see FIGS. 15 and 16). If the metal bar 44 is disposed generally contiguously with respect to the body 15 of the electrical connector assembly 12, the base bar 45 is appropriately sized to reach or expand to the bottom of the female openings 50 for making contact with a male adaptor.

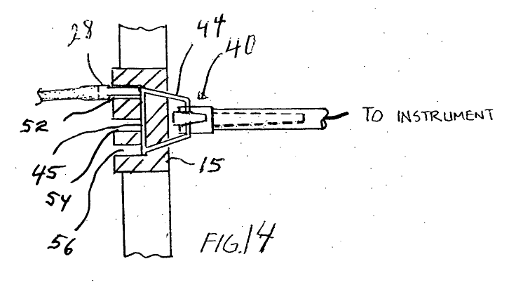

Female openings 50 may include any suitable number of openings, such as openings 52, 54 and 56 in FIG. 9, or openings 52, 54, 56, 58 and 60 for the embodiment of the invention in FIG. 15. As indicated, the base bar 45 of the metal bar 44 may define the bottom of the female openings 50, as illustrated in FIG. 14. Each female opening 50 is capable of receiving a male adapter, such as male adapter 28. For the embodiment of the invention illustrated in FIG. 13, female openings 52, 54 and 56 include electrical pinchers 62, 64 and 66, respectively, electrically coupled to metal bar 44 for engaging and electrically coupling male members 70, 72 and 74 of male adapters 28, 29 and 31 to metal bar 44 (more specifically to the base bar 45 of the metal bar 44) so that electrical current may pass from the metal bar 44 to the female opening 52 (as well as to female opening 54 and 56) and subsequently to the male adapter 28, more specifically from the metal bar 44 to the electrical pinchers 62, 64, and 66 within respective female openings 52, 54 and 56 to the male members 70, 72 and 74 of male adapters 28, 29 and 31, respectively. Each of the male adapters 28, 29 and 31 may be associated with file assemblies including a respective file (e.g., file 30) having a file stem (e.g., stem 30a) which differs in file diameter from the file stems of other files. As previously mentioned, files having file stems of increasing diameters are employed for sequentially enlarging a root canal, as previously mentioned.

The apex locator assembly 16 includes instrument 36, and an electrical conduit 38 connected to the instrument 36 and terminating in an electrical coupling assembly 40 (which may also function for holding a file as fully illustrated and described in co-pending patent application having patent application Ser. No. 10/133,269 and fully incorporated herein by reference thereto as if repeated verbatim immediately hereinafter). The coupling assembly 40 couples to a metal bar 44 that is electrically coupled with the female plug portions.

Openings 52, 54, 56, 58 and 60 for the embodiment of the invention in FIG. 15 may terminate in bottom electrical outlets 52a, 54a, 56a, 58a, and 60a which electrically engages electrical wire 99 that connects to terminal ends 44a and 44b of bar 44, as best shown in FIG. 16.

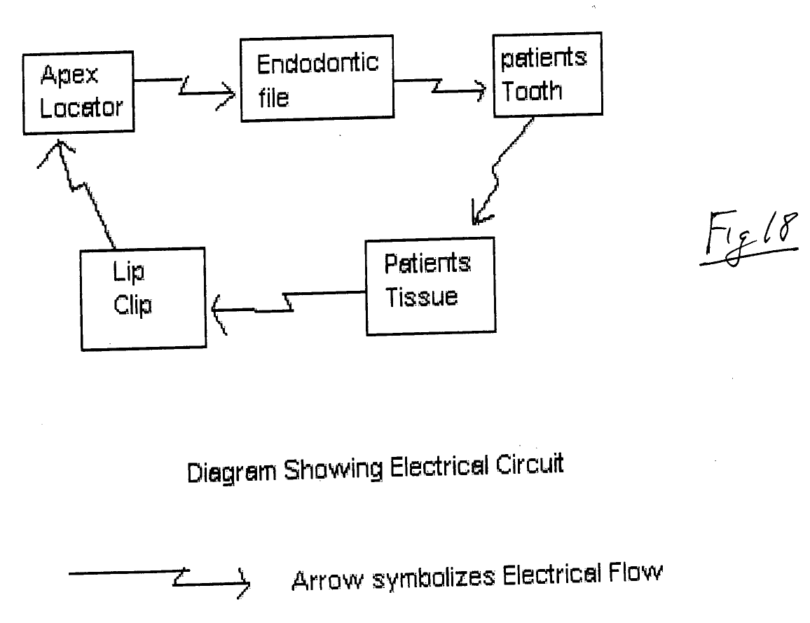

Referring now to FIG. 17 there is seen a schematic view of another embodiment of the invention showing an electrical conduit 100 having a male connector 102 mating with a female connector 104 which connects to the electrical conduit 38. Electrical conduit 38 passes through the rubber dam frame 25 for electrically coupling to the bottom electrical outlets (e.g., via electrical wire 99 which engages electrical conduit 38) for the female openings 50 in the electrical connector assembly 12. Thus, for this embodiment of the invention, the metal bar 44 is eliminated and is replaced by the assembly comprising conduit 100, male connector 102, female connector 104.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any directional arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. An assembly for conducting a dental procedure comprising:
a frame;
an electrical conductor assembly secured to said frame and including a connector body having at least one opening for receiving at least one adapter, and a conductor member for engaging the adapter; and
an electrical coupling assembly coupled to the conductor member.

2. The assembly of claim 1 additional comprising a file assembly including a file, a flexible electrical conductor coupled to said file, and an adapter secured to said flexible electrical conductor and removaly disposed in the opening of the connector body.

3. The assembly of claim 1 additionally comprising a flexible sheet member connected to said frame.

4. The assembly of claim 2 additionally comprising a flexible sheet member connected to said frame.

5. The assembly of claim 1 wherein said electrical conductor assembly comprises a metal bar.

6. The assembly of claim 5 wherein said metal bar passes through said connector body.

7. The assembly of claim 5 wherein said metal bar is secured to said frame and is generally contiguous to said connector body.

8. The assembly of claim 5 wherein said metal bar is secured to said frame and is generally spaced from said connector body.

9. A method for conducting a dental procedure comprising:
exposing a tooth through a flexible sheet member connected to a frame having secured thereto an electrical connector assembly; and
conducting a dental procedure on the exposed tooth.

10. The method of claim 9 wherein said conducting a dental procedure comprises passing current through the electrical connector assembly and through a file.

11. The method of claim 9 wherein said conducting a dental procedure comprises engaging the electrical connector assembly with a plurality of files having different diameters.
